(19) United States
(12) Patent Application Publication
(10) Pub. No.: US 2004/0082056 A1
(43) Pub. Date: Apr. 29, 2004

(54) Process for enzymatic hydrolysis of cyclic oligomers

(75) Inventors: Joe Jump, Raleigh, NC (US); Stephanie McCloskey, Wake Forest, NC (US)

Correspondence Address: NOVOZYMES NORTH AMERICA, INC., 500 FIFTH AVENUE, SUITE 1600, NEW YORK, NY, 10110, US

(73) Assignee: Novozymes North America, Inc., Franklinton, NC

(21) Appl. No.: 10/635,322

(22) Filed: Aug. 6, 2003

Related U.S. Application Data
(60) Provisional application No. 60/404,068, filed on Aug. 16, 2002.

(51) Int. Cl. C12S 11/00; C09B 67/00

(52) U.S. Cl. 435/263; 435/264; 8/401

(57) ABSTRACT

The present invention relates to a process for enzymatic hydrolysis of cyclic oligomers of poly(ethylene terephthalate), which process comprises subjecting the cyclic oligomer to the action of one or more lipolytic and/or biopolyester hydrolytic enzyme(s) and a nonionic, nonlinear surfactant.

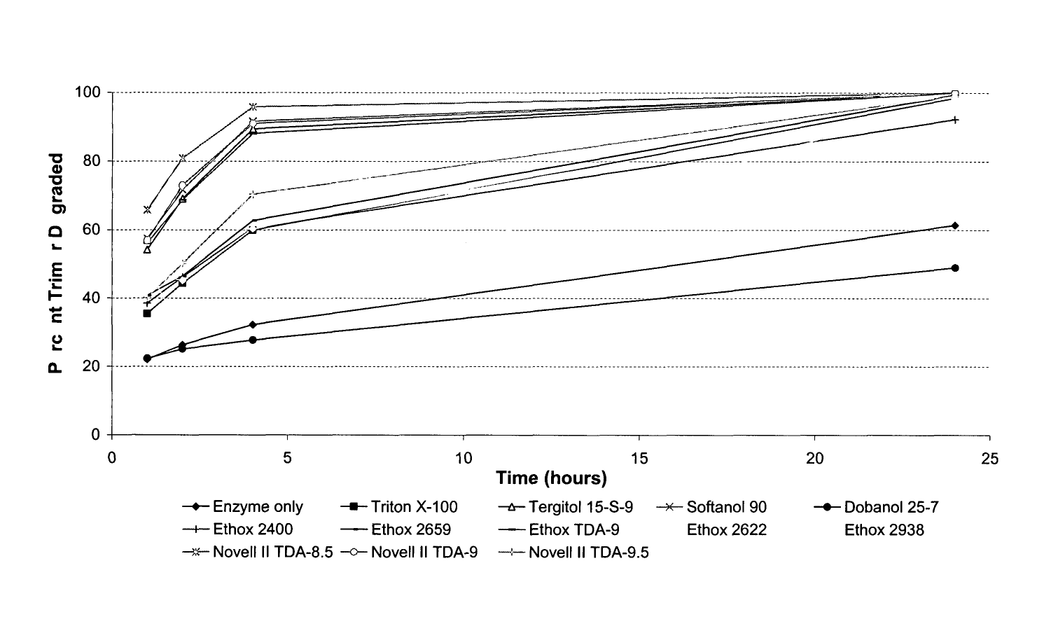

### CROSS-REFERENCE TO RELATED APPLICATIONS

This application claims, under 35 U.S.C. 119, the benefit of U.S. provisional application No. 60/404,068, filed Aug. 16, 2002 the content of which are fully incorporated herein by reference.

### FIELD OF THE INVENTION

The present invention relates to a process for enzymatic hydrolysis of cyclic oligomers of poly(ethylene terephthalate), which method comprises subjecting the cyclic oligomer to the action of one or more carboxylic ester hydrolases (polyester hydrolytic enzyme) and a nonionic, nonlinear surfactant.

### BACKGROUND OF THE INVENTION

Poly(ethylene terephthalate) fibers accounts for the main part of the polyester applied by the textile industry. The fibers are produced by e.g. poly-condensation of terephthalic acid and ethylene glycol, and drawing of fibers from a melt. During these processes, at high temperatures, cyclic oligomers, in particular cyclic tri(ethylene terephthalate), are formed in and on the fibers.

Cyclic oligomers tend to give fabrics with a content of poly(ethylene terephthalate) fibers a grayish appearance. This is due to deposits of cyclic oligomers on the surface of the fabric, which is particularly apparent after high temperature wet processes like HT (high temperature) dyeing. Cyclic oligomers can be removed by organic extraction, but such a process is not industrially feasible due to cost and problems in handling and regeneration of large quantities of organic solvents. Cyclic oligomers can also be removed by an alkaline post scouring step, but to be effective the alkaline treatment has to be severe and results in significant loss of fiber material, too. The cyclic oligomers are difficult to remove and may even be resistant to an alkaline post treatment [cf. G. Valk et al.; Melliand Textilberichte 1970 5 504-508]. Also, organic extraction of the cyclic oligomers is a technical possibility, but not industrially feasible.

Removel of cyclic oligomers can also be accomplished by hydrolysis with one or more hydrolytic enzymes (EP 0 882 084). The enzyme breaks the ring structure of the cyclic oligomer by hydrolyzing an ester bond. The resulting product creates less of a problem, because it can be removed under gentle conditions or even leftover in the product. The enzymatic treatment does not have the disadvantages valid for organic extraction and alkaline post scouring, in particular is does not require large quantities of organic solvent to be involved, and there is no significant loss of fiber material.

### SUMMARY OF THE INVENTION

The invention provides an enzymatic process for removal of cyclic oligomers of poly(ethylene terephthalate), in particular cyclic tri(ethylene terephthalate), by which process the cyclic oligomers are enzymatically hydrolyzed to linear fragments, which can then be removed under gentle conditions, or which may even remain in or on the fabric in hydrolyzed form. Thus the process of the invention avoids the need for harsh chemicals or organic extraction.

By subjecting a polyester fabric to the action of carboxylic ester hydrolases in combination with nonlinear, nonionic surfactants an improved effect is obtained. The enzymes interact with nonlinear, nonionic surfactants in a composition to improve the appearance of the polyester textile fabric such as improving the removal of cyclic oligomers on the surface of the polyester fibers.

Although not limited to any one theory or operation it is believed that these enzymes interact with nonlinear, nonionic surfactants in a composition thereby improving the enzymatic action of the enzyme on the textile fabric and consequently improving the appearance and quality of the polyester textile fabric such as improving the removal of cyclic oligomers on the surface of the polyester fibers.

Accordingly, in a first aspect, the invention provides a process for enzymatic hydrolysis of cyclic oligomers of poly(ethylene terephthalate), which process comprises subjecting the cyclic oligomer to the action of one or more carboxylic ester hydrolases and a nonlinear, nonionic surfactant.

In a second aspect, the invention provides a process for improving the appearance and quality of a polyester textile fabric, which process comprises treating the fabric with one or more carboxylic ester hydrolases and a nonlinear, nonionic surfactant.

### BRIEF DESCRIPTION OF DRAWINGS

The FIGURE shows the percent trimer degraded as a function of time for different surfactants.

### DETAILED DESCRIPTION OF THE INVENTION

The present invention relates to a process for enzymatic hydrolysis of cyclic oligomers of poly(ethylene terephthalate). More specifically the invention provides a process for enzymatic hydrolysis of cyclic oligomers of poly(ethylene terephthalate), which process comprises subjecting the cyclic oligomer to the action of one or more carboxylic ester hydrolases, in particular lipolytic and/or biopolyester hydrolytic enzyme(s) and a nonionic, nonlinear surfactant. In the context of this invention, a biopolyester is a polyester of biological origin. Further, in the context of the present invention the term “a” nonionic, nonlinear surfactant means “at least one” nonionic, nonlinear surfactant, e.g. one, two, three etc.

The process of the invention may in particular be applied to yarns or fabrics with a content of poly(ethylene terephthalate) fibers, during which process the content of cyclic oligomers, which were formed as byproducts during synthesis and processing of the fibers, becomes eliminated or at least significantly reduced thereby improving the appearance of the fabric. In the context of the present invention the term “improving the appearance” means that the visual look of the fabric is improved as compared to a fabric which has not been treated according to the invention.

### Polyester Fabrics

Poly(ethylene terephthalate) is synthesized by condensation, drawn into fibers from a melt, possibly cut to stables, possibly mixed with other fiber types, and spun to yarn. The yarn is dyed and knitted into cloth or made into carpets, or the yarn is woven into fabric and dyed. These processes can be followed by finishing (post treatment) steps.

During synthesis and drawing, cyclic oligomers of poly(ethylene terephthalate) are formed on and in the fibers. These cyclic oligomers are partly deposited on machinery, partly staying on/in the fibers, which turns out to give an undesirable grayish appearance of the final fabric or carpet.

According to the present invention, removal of cyclic oligomers, in particular cyclic trimers, can be improved by hydrolysis with one or more hydrolytic enzymes in the presence of a nonionic, nonlinear surfactant.

The process of the invention is readily applicable in the textile industry as it can be carried out using existing wet processing apparatus, such as in a beam dyer, a Pad-Roll, a Jigger/Winch, a J-Box, or Pad-Steam types of apparatus. The process preferably takes place during the finishing (post treatment) step.

In a preferred embodiment, the process of the invention may be accomplished on cyclic oligomers of poly(ethylene terephthalate) present on and/or in fibers or in yarn or fabric made (or partially made) from poly(ethylene terephthalate) fibers. Thus, the polyester yarn or fabric may be any yam or fabric that is made from pure poly(ethylene terephthalate), or that is made from blends of poly(ethylene terephthalate) fibers and any other material conventionally used for making yams or fabrics.

Thus, in a preferred embodiment, the invention provides a process for enzymatic treatment of polyester fibers, which process comprises subjecting the polyester fiber or fabric to the action of one or more carboxylic ester hydrolases, in particular lipolytic and/or biopolyester hydrolytic enzyme(s) and a nonionic, nonlinear surfactant.

The polyester fabric may be any fabric or fabric blend comprising polyester. Preferably the fabric comprises more than 50% (w/w) of polyester, in particular more than 75% (w/w) of polyester, more than 90% (w/w) of polyester, or more than 95% (w/w) of polyester. In a most preferred embodiment, the process of the invention is applied to fabrics or textiles or yams consisting essentially of poly(ethylene terephthalate) polyester material, i.e. pure poly(ethylene terephthalate) polyester material. Examples of fabric blends are polyester/cotton, polyester/wool, polyester/cellulose acetate and polyester/nylon.

### Hydrolytic Enzymes

The enzymatic process of the invention may be accomplished using any carboxylic ester hydrolases which is capable of hydrolyzing cyclic oligomers of poly(ethylene terephthalate), in particular lipolytic enzyme and/or any biopolyester hydrolytic enzyme. Such enzymes are well known and defined in the literature, cf. e.g. Borgström B and Brockman H L, (Eds.); Lipases; Elsevier Science Publishers B. V., 1984, and Kolattukudy P E; The Biochemistry of Plants, Academic Press Inc., 1980 4 624-631. Examples of enzymes as defined above are typically found amongst enzymes classified in EC 3.1.1 Carboxylic Ester Hydrolases according to Enzyme Nomenclature (available at http://www.chem.qmw.ac.uk/iubmb/enzyme, or from Enzyme Nomenclature 1992 (Academic Press, San Diego, Calif., with Supplement 1 (1993), Supplement 2 (1994), Supplement 3 (1995), Supplement 4 (1997) and Supplement 5 (in Eur. J. Biochem. 1994, 223, 1-5; Eur. J. Biochem. 1995, 232, 1-6; Eur. J. Biochem. 1996, 237, 1-5; Eur. J. Biochem. 1997, 250; 1-6, and Eur. J. Biochem. 1999, 264, 610-650; respectively), which are enzymes capable of hydrolysing carboxylic ester bonds.

Lipolytic Enzymes

In the context of this invention lipolytic enzymes include lipases, esterases, phospholipases, and lyso-phospholipases. More specifically the lipolytic enzyme may be a lipase as classified by EC 3.1.1.3, EC 3.1.1.23 and/or EC 3.1.1.26, an esterase as classified by EC 3.1.1.1, EC 3.1.1.2, EC 3.1.1.6, EC 3.1.1.7, and/or EC 3.1.1.8, a phospholipase as classified by EC 3.1.1.4 and/or EC 3.1.1.32, and a lyso-phospholipase as classified by EC 3.1.1.5.

The lipolytic enzyme preferably is of microbial origin, in particular of bacterial, of fungal or of yeast origin.

In a particular embodiment, the lipolytic enzyme used may be derived from a strain of Absidia, in particular Absidia blakesleena and Absidia corymbifera, a strain of Achromobacter, in particular Achromobacter iophagus, a strain of Aeromonas, a strain of Alternaria, in particular Alternaria brassiciola, a strain of Aspergillus, in particular Aspergillus niger and Aspergillus flavus, a strain of Achromobacter, in particular Achromobacter iophagus, a strain of Aureobasidium, in particular Aureobasidium pullulans, a strain of Bacillus, in particular Bacillus pumilus, Bacillus strearothermophilus and Bacillus subtilis, a strain of Beauveria, a strain of Brochothrix, in particular Brochothrix thermosohata, a strain of Candida, in particular Candida cylindracea (Candida rugosa), Candida paralipolytica, and Candida antarctica, a strain of Chromobacter, in particular Chromobacter viscosum, a strain of Coprinus, in particular Coprinus cinerius, a strain of Fusarium, in particular Fusarium oxysporum, Fusarium solani, Fusarium solani pisi, and Fusarium roseum culmorum, a strain of Geotricum, in particular Geotricum penicillatum, a strain of Hansenula, in particular Hansenula anomala, a strain of Humicola, in particular Humicola brevispora, Humicola brevis var. thermoidea, and Humicola insolens, a strain of Hyphozyma, a strain of Lactobacillus, in particular Lactobacillus curvatus, a strain of Metarhizium, a strain of Mucor, a strain of Paecilomyces, a strain of Penicillium, in particular Penicillium cyclopium, Penicillium crustosum and Penicillium expansum, a strain of Pseudomonas in particular Pseudomonas aeruginosa, Pseudomonas alcaligenes, Pseudomonas cepacia (syn. Burkholderia cepacia), Pseudomonas fluorescens, Pseudomonas fragi, Pseudomonas maltophilia, Pseudomonas mendocina, Pseudomonas mephitica lipolytica, Pseudomonas alcaligenes, Pseudomonas plantari, Pseudomonas pseudoalcaligenes, Pseudomonas putida, Pseudomonas stutzeri, and Pseudomonas wisconsinensis, a strain of Rhizoctonia, in particular Rhizoctonia solani, a strain of Rhizomucor, in particular Rhizomucor miehei, a strain of Rhizopus, in particular Rhizopus japonicus, Rhizopus microsporus and Rhizopus nodosus, a strain of Rhodosporidium, in particular Rhodosporidium toruloides, a strain of Rhodotorula, in particular Rhodotorula glutinis, a strain of Sporobolomyces, in particular Sporobolomyces shibatanus, a strain of Thermomyces, in particular Thermomyces lanuginosus (formerly Humicola lanuginosa), a strain of Thiarosporella, in particular Thiarosporella phaseolina, a strain of Trichoderma, in particular Trichoderma harzianum, and Trichoderma reesei, and/or a strain of Verticillium.

In a more preferred embodiment, the lipolytic enzyme used according to the invention is derived from a strain of Aspergillus, a strain of Achromobacter, a strain of Bacillus, a strain of Candida, a strain of Chromobacter, a strain of Fusarium, a strain of Humicola, a strain of Hyphozyma, a strain of Pseudomonas, a strain of Rhizomucor, a strain of Rhizopus, or a strain of Thermomyces.

In a even more preferred embodiment, the lipolytic enzyme used according to the invention is derived from a strain of Bacillus pumilus, a strain of Bacillus stearothermophilus a strain of Candida cylindracea, a strain of Candida antarctica, in particular Candida antarctica Lipase B (obtained as described in WO 88/02775), a strain of Humicola insolens, a strain of Hyphozyma, a strain of Pseudomonas cepacia, or a strain of Thermomyces lanuginosus.

Biopolyester Hydrolytic Enzymes

In the context of this invention biopolyester hydrolytic enzyme include esterases and poly-hydroxyalkanoate depolymerases, in particular poly-3-hydroxyalkanoate depolymerases. An esterase is a lipolytic enzyme as well as a biopolyester hydrolytic enzyme.

In a more preferred embodiment, the esterase is a cutinase (EC 3.1.1.74) or a suberinase. In the context of this invention, a cutinase is an enzyme capable of degrading cutin, cf. e.g. Lin T S & Kolattukudy P E, J. Bacteriol. 1978 133 (2) 942-951, a suberinase is an enzyme capable of degrading suberin, cf. e.g., Kolattukudy P E; Science 1980 208 990-1000, Lin T S & Kolattukudy P E; Physiol. Plant Pathol. 1980 17 1-15, and The Biochemistry of Plants, Academic Press, 1980 Vol. 4 624-634, and a poly-3-hydroxyalkanoate depolymerase is an enzyme capable of degrading poly3-hydroxyalkanoate, cf. e.g. Foster et al., FEMS Microbiol. Left. 1994 118 279-282. Cutinases, for instance, differ from classical lipases in that no measurable activation around the critical micelle concentration (CMC) of the tributyrine substrate is observed. Also, cutinases are considered belonging to a class of serine esterases.

The biopolyester hydrolytic enzyme preferably is of microbial origin, in particular of bacterial, of fungal or of yeast origin.

In a preferred embodiment, the biopolyester hydrolytic enzyme is derived from a strain of Aspergillus, in particular Aspergillus oryzae, a strain of Alternaria, in particular Alternaria brassiciola, a strain of Fusarium, in particular Fusarium solani, Fusarium solani pisi, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, or a strain of Ulocladium, in particular Ulocladium consortiale. In a most preferred embodiment the biopolyester hydrolytic enzyme is a cutinase derived from a strain of Humicola insolens, in particular the strain Humicola insolens DSM 1800.

WO 00/34450 and WO 01/92502 disclose different cutinase variants of Humicola insolens and Fusarium solani pisi and methods of production of said variants and is hereby incorporated by reference.

In another preferred embodiment, the poly-3-hydroxyalkanoate depolymerase is derived from a strain of Alcaligenes, in particular Alcaligenes faecalis, a strain of Bacillus, in particular Bacillus megaterium, a strain of Camomonas, in particular Camomonas testosteroni, a strain of Penicillium, in particular Penicillium funiculosum, a strain of Pseudomonas, in particular Pseudomonas fluorescens, Pseudomonas lemoignei and Pseudomonas oleovorans, or a strain of Rhodospirillum, in particular Thodospirillum rubrum.

As disclosed above, the enzymes may be derived or obtained from any origin, including, bacterial, fungal, yeast or mammalian origin. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g. having one or more amino acids which are deleted, inserted and/or substituted, i.e., a recombinantly produced enzyme which is a mutant and/or a fragment of a native amino acid sequence or an enzyme produced by nucleic acid shuffling processes known in the art. Within the meaning of a native enzyme are included natural variants. Furthermore, the term “derived” includes enzymes produced synthetically by, e.g., peptide synthesis. The term “derived” also encompasses enzymes which have been modified e.g. by glycosylation, phosphorylation, or by other chemical modification, whether in vivo or in vitro. The term “obtained” in this context means that the enzyme has an amino acid sequence identical to a native enzyme. The term encompasses an enzyme that has been isolated from an organism where it is present natively, or one in which it has been expressed recombinantly in the same type of organism or another, or enzymes produced synthetically by, e.g., peptide synthesis. With respect to recombinantly produced enzymes the terms “obtained” and “derived” refers to the identity of the enzyme and not the identity of the host organism in which it is produced recombinantly.

The enzymes may also be purified. The term “purified” as used herein covers enzymes free from other components from the organism from which it is derived. The term “purified” also covers enzymes free from components from the native organism from which it is obtained. The enzymes may be purified, with only minor amounts of other proteins being present. The expression “other proteins” relate in particular to other enzymes. The term “purified” as used herein also refers to removal of other components, particularly other proteins and most particularly other enzymes present in the cell of origin of the enzyme of the invention. The enzyme may be “substantially pure,” that is, free from other components from the organism in which it is produced, that is, for example, a host organism for recombinantly produced enzymes. In preferred embodiment, the enzymes are at least 75% (w/w) pure, more preferably at least 80%, at least 85%, at least 90%, at least 95%, at least 96%, at least 97%, at least 98%, or at least 99% pure. In another preferred embodiment, the enzyme is 100% pure.

The enzyme may be in any form suited for the use in the treatment process, such as e.g. in the form of a dry powder or granulate, a non-dusting granulate, a liquid, a stabilized liquid, or a protected enzyme. Granulates may be produced, e.g. as disclosed in U.S. Pat. Nos. 4,106,991 and U.S. Pat. No. 4,661,452, and may optionally be coated by methods known in the art. Liquid enzyme preparations may, for instance, be stabilized by adding stabilizers such as a sugar, a sugar alcohol or another polyol, lactic acid or another organic acid according to established methods. Protected enzymes may be prepared according to the method disclosed in EP 238,216.

### Surfactant

The surfactants for use in the present invention are nonionic, non-linear surfactants, such as a nonionic, branched surfactant. The term “nonionic” is well defined in the literature and generally refers to surfactants that do not possess ionizable functional groups. In the context of the present invention, the term “non-linear” is defined as a surfactant whose hydrophobic portion of the molecular structure is of a branched origin and possesses chain branching. Chain branching is defined in the context of the present invention as a molecular structure possessing one or more carbon atoms, preferably one carbon atom to about ten carbon atoms, directly bonded to more than one carbon atoms, preferably two or three carbon atoms, or whose hydrophobic portion is derived from a secondary or tertiary alcohol.

Polyethylene, polypropylene, and polybutylene oxide condensates of alkyl phenols are suitable for use as the nonionic, non-linear surfactant of the surfactant systems of the present invention, with the polyethylene oxide condensates being preferred. These compounds include the condensation products of alkyl phenols having an alkyl group containing from about 6 to about 14 carbon atoms, preferably from about 8 to about 14 carbon atoms, in either a straight chain or branched-chain configuration. In a preferred embodiment, the ethylene oxide is present in an amount equal to from about 2 to about 25 moles, more preferably from about 3 to about 15 moles, of ethylene oxide per mole of alkyl phenol. Commercially available nonionic, nonlinear surfactants of this type include Igepal™ CO-630, marketed by the GAF Corporation, Triton™ X-45, X-114, X-100 and X-102, and Terginol NP, preferably Terginol NP9 all marketed by DOW/Union Carbide. These surfactants are commonly referred to as alkylphenol alkoxylates (e.g., alkyl phenol ethoxylates).

The condensation products of secondary aliphatic alcohols with about 1 to about 25 moles of ethylene oxide are suitable for use as the nonionic surfactant of the nonionic surfactant systems of the present invention. The alkyl chain of the aliphatic alcohol generally contains from about 8 to about 22 carbon atoms. Preferred are the condensation products of alcohols having an alkyl group containing from about 8 to about 20 carbon atoms, more preferably from about 10 to about 18 carbon atoms, with from about 2 to about 15 moles of ethylene oxide per mole of alcohol, preferably about 5 to about 15 moles of ethylene oxide and most preferably from about 7 to about 13 moles of ethylene oxide per mole of alcohol. Examples of commercially available nonionic surfactants of this type include Tergitol™ 15-S-9 (the condensation product of C₁₁-C₁₅ secondary alcohol with 9 moles ethylene oxide), Terginol™ 15-S-12 and Softanol 90. Preferred range of HLB in these products is from 8-15 and most preferred from 10-14.

Also useful as the nonionic surfactant of the surfactant systems of the present invention are the condensation products of styrenated phenolics with ethylene oxide. In a preferred embodiment, the ethylene oxide is present in an amount equal to from about 2 to about 25 moles, more preferably from about 9 to about 15 moles, of ethylene oxide per mole of styrenated phenol. Examples of commercially available styrenated phenols of this type are Ethox 2622, Ethox 2659 and Ethox 2938.

The condensation products of branched aliphatic alcohols such as tridecylalcohol with about 1 to about 25 moles of ethylene oxide are suitable for use as the nonionic surfactant of the nonionic surfactant systems of the present invention. Commercially available examples of this surfactant class are Novell II TDA-6.6, Novell II TDA-7, Novell II TDA-8.5, Novell II TDA-9, Novell II TDA-9.5 and Novell II TDA-11.

### Process Conditions

The treatment according to the present invention may be carried out at conditions chosen to suit the selected enzymes and surfactants according to principles well known in the art. It will be understood that each of the reaction conditions, such as, e.g., concentration/dose of enzyme/surfactant, pH, temperature, and time of treatment, may be varied, depending upon, e.g., the source of the enzyme, the type of surfactant, the method in which the treatment is performed. It will further be understood that optimization of the reaction conditions may be achieved using routine experimentation by establishing a matrix of conditions and testing different points in the matrix.

The enzymatic treatment according to the present invention preferably is carried out as a wet process. It is at present contemplated that a suitable liquor:textile ratio may be in the range of from about 20:1 to about 1:1, preferentially in the range of from about 15:1to about 5:1.

The enzyme(s) may be dosed in an amount sufficient to hydrolyze the cyclic oligomer, preferably in a total amount of from about 0.001 g/kg to about 5 g/kg enzyme protein per yarn or fabric, more preferably from about 0.001 g/kg to about 0.5 g/kg.

The amount of surfactant employed in the method of the invention also depends on different parameters such as the enzyme applied. The amount of surfactant is preferably from about 0.05% to about 5% w/w, more preferably from about 0.1 to about 1% w/w, most preferably around 1% w/w.

The enzymatic hydrolysis is preferably carried out in the temperature range of from about 30° C. to about 100° C., more preferably from about 50° C. to about 100° C. The pH range may, dependent on the enzyme(s) applied, be from about pH 4 to about pH 12, preferably from about pH 6 to about pH 10, more preferably around pH 8. A suitable reaction time may be in the range of from about 15 minutes to about 3 hours.

The process of the invention may further comprise the addition of one or more chemicals capable of improving the enzyme-substrate interaction (in order to improve the substrate's accessibility and/or dissolve reaction products), which chemicals may be added prior to, or simultaneously with the enzymatic treatment. Such chemicals may in particular be wetting agents and dispersing agents etc., or mixtures thereof.

The process of the invention may optionally comprise a rinsing step during which the hydrolyzed cyclic oligomers are subjected to rinsing, in particular to rinsing with dilute alkali. Dilute alkali dissolves linear fragments of the cyclic oligomers, and may to some extent further hydrolyze these linear fragments. In the context of this invention dilute alkali comprise aqueous solutions having a pH in the range of from about pH 7 to about pH 11, more preferably of from about pH 7 to about pH 10, most preferred of from about pH 7 to about pH 9. A buffer may be added to the medium.

The materials may also be subject to additional processes. For example, for textile materials, the preparation may include the application of finishing techniques, and other treatment processes, such as imparting antimicrobial properties (e.g., using quaternary ammonium salts), flame retardancy (e.g., by phosphorylation with phosphoric acid or urea), increasing absorbency (by coating or laminating with polyacrylic acid), providing an antistatic finish (e.g., using amphoteric surfactants (N-oleyl-N, N-dimethylglycine)), providing a soil release finish (e.g., using NaOH), providing an antisoiling finish (e.g., using a fluorochemical agent), and providing an antipilling finish (e.g., using NaOH, alcohol).

The invention will further be described by reference to the following detailed examples. These examples are provided for the purpose of illustration only, and are not intended to be limiting unless otherwise specified.

### MATERIALS AND METHODS

### Lipase Activity (LU)

The lipolytic activity was determined using tributyrine as substrate. This method was based on the hydrolysis of tributyrin by the enzyme, and the alkali consumption is registered as a function of time.

One Lipase Unit (LU) is defined as the amount of enzyme which, under standard conditions (i.e. at 30.0 degree celsius; pH 7.0; with Gum Arabic as emulsifier and tributyrine as substrate) liberates 1 micro mol titrable butyric acid per minute.

A folder AF 95/5 describing this analytical method in more detail is available upon request to Novozymes A/S, Denmark, which folder is hereby included by reference.

### Medium and Substrates

Enzymes: Cutinase derived from Humicola insolens DSM 1800 according to U.S. Pat. No. 5,827,719 with the following substitutions E6Q, A14P, E47K, R51P, E179Q, G8D, N15D, S48E, A88H, N91H, A130V, R189V, T29M, T166I, L167P.

Nonionic Surfactants:

| Surfactant | Chemistry | Manufacturer |
|---|---|---|
| Triton X-100 | Octyphenol ethoxylate | Union Carbide (Dow) |
| | (nonlinear) | |
| Terginol 15-S-9 | Alcohol Ethoxylate | Union Carbide (Dow) |
| | (nonlinear) | |
| Softanol 90 | Alcohol Ethoxylate | Honeywell & Stein |
| | (C12-14) (nonlinear) | BPChem; INEOS |
| Dobanol 25-7(aka | Alcohol Ethoxylate (linear, | Shell Chemicals |
| Neodol 25-7) | unbranched) | |
| Ethox 2400 | POE Tridecyl alcohol | Ethox |
| | (nonlinear) | |
| Ethox 2659 | POE styrenated phenol | Ethox |
| | (nonlinear) | |
| Ethox TDA-9 | POE Tridecyl Alcohol | Ethox |
| | (nonlinear) | |
| Ethox 2622 | POE styrenated phenol | Ethox |
| | (nonlinear) | |
| Ethox 2938 | POE styrenated phenol | Ethox |
| | (nonlinear) | |
| Novell II TDA-8.5 | POE Tridecyl Alcohol | Sassol (Vista) |
| | (nonlinear) | |
| Novell II TDA-9 | POE Tridecyl Alcohol | Sassol (Vista) |
| | (nonlinear) | |
| Novell II TDA-9.5 | POE Tridecyl Alcohol | Sassol (Vista) |
| | (nonlinear) | |

### Methods

HPLC analysis was carried out for all studies in accordance with the following specifications:

| HPLC | Agilent 1100 Series | |
|---|---|---|
| Solvent A | Filtered deionized water = 0.1% Trifluoroacetic acid | |
| Solvent B | Acetonitrile | |
| Column | Alltech, Adsorbosil C18, 5 micro, 250 mm × 4.6 mm | |
| Flow | 0.8 mL/min | |
| Run time | 21 min. | |
| Post time | 6 min. | |
| Injection | 20 micro L | |
| Gradient | Time (min.) | % B |
| | 0 | 10 |
| | 2 | 20 |
| | 5 | 30 |
| | 8 | 50 |
| | 10 | 70 |
| | 12 | 95 |
| | 21 End | 95 |

| | |
|---|---|
| Signal | 254 nm |
| Temperature | 25 degree celsius |

### EXAMPLES

The invention is further illustrated with reference to the following examples which are not intended to be in any way limiting to the scope of the invention as claimed.

### Example 1

In this example, different surfactants were tested in combination with a variant of the cutinase derived from Humicola insolens DSM 1800 disclosed in U.S. Pat No. 5,827,719.

To a clean, dry test tube (1.5 cm diameter) was added a magnetic stirbar (10×4 mm), 5 mL 7 mM Sodium bicarbonate buffer (pH 8.2), 3.1 mg powdered polyester oligomer (obtained from the Soxlet Extraction of polyester resin with chloroform), 0.5% w/w surfactant and 200 LU/ml enzyme calculated base on final volume.

The content of the test tube was heated in a water bath at 70 degree celsius. Aliquots (100 microL) were removed periodically, diluted into 1.0 mL of dimethylformamide, and subjected to HPLC for analysis using the conditions described above under the section Materials and Methods. Degradation of polyester was determined by subtracting the area percent under the curve corresponding to oligomer from 100%.

The results are shown in the FIGURE. The FIGURE shows that an increase in degration of trimer when treating with a combination of enzyme and non-ionic, nonlinear surfactant compared to the treatment with enzyme alone or a combination of enzyme and Dobanol 25-7, which is a non-ionic, linear surfactant.

1. A process for enzymatic hydrolysis of cyclic oligomers of poly(ethylene terephthalate), which process comprises subjecting the cyclic oligomer to the action of one or more carboxylic ester hydrolases, and a nonionic, nonlinear sufactant.

2. The process according to claim 1, which process comprises subjecting the cyclic oligomer to the action of one or more lipolytic and/or biopolyester hydrolytic enzyme(s).

3. The process according to claim 2, wherein the lipolytic enzyme is a lipase derived from the group consisting of a strain of Aspergillus, a strain of Achromobacter, a strain of Bacillus, a strain of Candida, a strain of Chromobacter, a strain of Fusarium, a strain of Humicola, a strain of Hyphozyma, a strain of Pseudomonas, a strain of Rhizomucor, a strain of Rhizopus, and a strain of Thermomyces.

4. The process according to claim 3, wherein the lipolytic enzyme is a lipase derived from the group consisting of a strain of Bacillus pumilus, a strain of Bacillus stearothermophilus a strain of Candida cylindracea, a strain of Candida antarctica, a strain of Humicola insolens, a strain of Hyphozyma, a strain of Pseudomonas cepacia, or a strain of Thermomyces lanuginosus.

5. The process according to claim 2, wherein the biopolyester hydrolytic enzyme is a cutinase, or a suberinase.

6. The process according to claim 5, wherein the biopolyester hydrolytic enzyme is derived from the group consisting of a strain of Aspergillus, in particular Aspergillus oryzae, a strain of Alternaria, in particular Alternaria brassiciola, a strain of Fusarium, in particular Fusarium solani, Fusarium solani pisi, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, or a strain of Ulocladium, in particular Ulocladium consortiale.

7. The process according to claim 6, wherein the enzyme is a cutinase derived from a strain of Humicola insolens, in particular the strain Humicola insolens DSM 1800.

8. The process according to claim 1, wherein the surfactant is selected from the group consisting of nonionic, branched surfactant condensation products of alkyl phenols, condensation products of secondary aliphatic alcohols, condensation products of styrenated phenolics and condensation products of branched aliphatic alcohols.

9. The process according to claim 1, wherein the surfactant is selected from the group consisting of Triton X-100, Terginol NP9, Tergitol 15-S-9, Terginol 15-S-12, Softanol 90, Ethox 2400, Ethox 2659, Ethox TDA-9, Ethox 2622, Ethox 2938, Novell II TDA-6.6, Novell II TDA-7, Novell II TDA-8.5, Novell II TDA-9, Novell II TDA-9.5 and Novell II TDA-11.

10. The process according to claim 1, wherein the enzymatic action is followed by a rinsing step, during which step hydrolyzed cyclic oligomer is subjected to treatment with an alkaline solution.

11. The process according to claim 1, wherein the cyclic oligomer is present in and on the fibers of a polyester containing fabric or yarn.

12. The process according to claim 1, wherein the cyclic oligomer is cyclic tri(ethylene terephthalate).

13. A process for improving the appearance of a polyester textile fabric, which process comprises treating the fabric with one or more carboxylic ester hydrolases and a nonlinear, nonionic surfactant.
